(19) United States
(12) Patent Application Publication
(10) Pub. No.: US 2014/0129673 A1
(43) Pub. Date: May 8, 2014

(54) WIRELESS COMMUNICATION TERMINAL, WIRELESS COMMUNICATION SYSTEM, WIRELESS COMMUNICATION METHOD, AND COMPUTER-READABLE DEVICE

(71) Applicant: Olympus Corporation, Tokyo (JP)

(72) Inventors: Kazuyuki Shibuya, Sagamihara-shi (JP); Akihiko Sakamoto, Sagamihara-shi (JP)

(73) Assignee: OLYMPUS CORPORATION, Tokyo (JP)

(21) Appl. No.: 14/042,970

(22) Filed: Oct. 1, 2013

(30) Foreign Application Priority Data
Nov. 7, 2012 (JP) 2012-245322

(51) Int. Cl. H04L 29/06

(52) U.S. Cl. CPC H04L 65/608
USPC 709/217

(57) ABSTRACT

A wireless communication terminal includes a network-constructing unit, a receiving unit that receives a participation request from a first terminal that is not participating in the wireless network, an estimating unit that estimates whether or not the first terminal is to perform wireless communication of streaming data used for streaming of content based on information received from the first terminal, a storage unit that stores the first terminal as a specific terminal when the first terminal is estimated to perform the wireless communication of the streaming data, a communication release unit that performs a process of releasing wireless communication with a second terminal that is participating in the wireless network when the first terminal is estimated to perform the wireless communication of the streaming data, and a wireless communication unit that performs the wireless communication of the streaming data with the specific terminal after the wireless communication with the second terminal is released.

### BACKGROUND OF THE INVENTION

1. Field of the Invention

The present invention relates to a wireless communication terminal, a wireless communication system, a wireless communication method, and a computer-readable device.

Priority is claimed on Japanese Patent Application No. 2012-245322, filed Nov. 7, 2012, the content of which is incorporated herein by reference.

2. Description of Related Art

With the increase in the speed of wireless local area networks (LANs) and the spread of a quality of service (QoS), opportunities to communicate videos between devices via wireless LANs have increased. From users, there is a demand for high-quality video communication such as a high-resolution and low-compression (or non-compression) video or low-delay communication between a video source terminal and a video-reproducing terminal. For this reason, an amount of data of video communication occupying communication in a wireless LAN network increases, and preferential communication tends to be demanded.

In a wireless LAN network (infrastructure network) providing a general access point (hereinafter referred to as an “AP”), there are cases in which video communication is performed between terminals. In this case, video communication is performed via an AP or communication is performed via a terminal other than a terminal that performs video communication in the same network, and thus an amount of data that can be transmitted in video communication is reduced, and an amount of delay increases. For this reason, it is difficult to satisfy the user's needs such as high-quality video communication.

In order to solve the above problem, in recent years, terminals such as PCs or TVs, or mobile telephones employ a soft AP for implementing an AP function through software. Direct video communication can be performed between a video source terminal and a video-reproducing terminal such that one of a video source terminal and a video-reproducing terminal functions as a soft AP and generates a network, and the other terminal is connected to the terminal that operates as the soft AP. Thus, a large amount of data can be communicated with a low delay, and the possibility of high-quality video communication increases.

Meanwhile, the purpose of a network generated by the soft AP is not limited to video communication, and a terminal that can operate as a video source can be connected to the soft AP that does not support video communication but has a purpose (for example, data backup) other than video communication. Further, in order to newly perform communication with the video source terminal, the video-reproducing terminal can be connected to the soft AP. However, in a network topology at this time, the video source terminal and the video-reproducing terminal are connected to the soft AP having nothing to do with video communication, and thus it is difficult to perform video communication directly between the video source terminal and the video-reproducing terminal.

In Japanese Unexamined Patent Application, First Publication No. 2011-244151, a technique is disclosed in which when a new terminal is connected to a network of a soft AP, a network topology is changed, and thus a service provided or used by each terminal is effectively used. For example, in this example, the network topology is changed so that the video source terminal operates as the soft AP, and a terminal that does not support video communication and the video-reproducing device are connected to the video source terminal. As a result, video communication can be performed directly between the video source terminal and the video-reproducing terminal.

### SUMMARY OF THE INVENTION

According to a first aspect of the present invention, a wireless communication terminal includes a network-constructing unit that constructs a wireless network, a receiving unit that receives a participation request from a first terminal that is not participating in the wireless network constructed by the network-constructing unit, an estimating unit that estimates whether or not the first terminal is to perform wireless communication of streaming data used for streaming of content based on information received from the first terminal when the participation request is received, a storage unit that stores the first terminal as a specific terminal when the first terminal is estimated to perform the wireless communication of the streaming data, a communication release unit that performs a process of releasing wireless communication with a second terminal that is participating in the wireless network constructed by the network-constructing unit when the first terminal is estimated to perform the wireless communication of the streaming data, and a wireless communication unit that performs the wireless communication of the streaming data with the specific terminal stored in the storage unit after the wireless communication with the second terminal is released.

According to a second aspect of the present invention, in the wireless communication terminal of the first aspect, after the wireless network constructed by the network-constructing unit is released, the wireless communication unit may perform the wireless communication of the streaming data with the specific terminal stored in the storage unit via a network newly constructed by the network-constructing unit or by a third terminal other than the specific terminal stored in storage unit.

According to a third aspect of the present invention, in the wireless communication terminal of the second aspect, the communication release unit may perform a process of notifying the second terminal of release of the wireless network, and then release the wireless network.

According to a fourth aspect of the present invention, in the wireless communication terminal of the third aspect, the communication release unit may perform a process of notifying the second terminal that is in a state in which data communication of a predetermined protocol has begun and before the data communication has ended of release of the wireless network, among all of the second terminals.

According to a fifth aspect of the present invention, in the wireless communication terminal of the third aspect, the communication release unit may perform a process of notifying the second terminal that has performed data communication of a predetermined protocol within a certain past period of time of release of the wireless network, among all of the second terminals.

According to a sixth aspect of the present invention, in the wireless communication terminal of the third aspect, when information related to a timing at which the wireless network is released is included in a response frame from the second terminal that is given notification of releases of the wireless network, the communication release unit may release the wireless network at a timing corresponding to the information.

According to a seventh aspect of the present invention, in the wireless communication terminal of the second aspect, the network-constructing unit may newly construct a wireless network after the wireless network is released.

According to an eighth aspect of the present invention, in the wireless communication terminal of the seventh aspect, when the participation request is received from each of a plurality of the first terminals, the estimating unit may estimate whether or not each of the first terminals is to perform the wireless communication of the streaming data used for streaming of content based on information received from each of the first terminals, the storage unit may store each of the first terminals as a specific terminal when it is estimated that each of the first terminals is to perform the wireless communication of the streaming data, and the wireless communication unit may perform the wireless communication of the streaming data with a plurality of specific terminals stored in the storage unit via a newly constructed wireless network when a plurality of first terminals are estimated to perform the wireless communication of the streaming data.

According to a ninth aspect of the present invention, in the wireless communication terminal of the eighth aspect, the streaming data may include video data and audio data, and the wireless communication unit may wirelessly transmit the video data to some of the plurality of specific terminals stored in the storage unit via a newly constructed wireless network, and wirelessly transmit the audio data to the specific terminals other than the specific terminal to which the video data has been wirelessly transmitted among the plurality of specific terminals stored in the storage unit via a newly constructed wireless network.

According to a tenth aspect of the present invention, the wireless communication terminal of the seventh aspect may further include a response control unit that controls the wireless communication unit to wirelessly transmit a response frame representing rejection of participation to the third terminal that has made a participation request or not to wirelessly transmit the response frame to the participation request, after a wireless network is newly constructed by the network-constructing unit, when the participation request is received from the third terminal that is not participating in the wireless network.

According to an eleventh aspect of the present invention, in the wireless communication terminal of the tenth aspect, the response control unit controls the wireless communication unit to wirelessly transmit a response frame that includes information representing that the number of terminals that are participating in the wireless network is a predetermined number or more and represents rejection of participation to the third terminal that has made the participation request, when the number of terminals that are participating in a wireless network newly constructed by the network-constructing unit is a predetermined number or more.

According to a twelfth aspect of the present invention, the wireless communication terminal of the seventh aspect may further include a communication-setting unit that, after a wireless network is newly constructed by the network-constructing unit, when a second participation request is received from the third terminal that is not participating in the wireless network, sets a ratio of data communication performed along with the specific terminal stored in the storage unit to be higher than a ratio of data communication performed along with the third terminal, and the wireless communication unit may perform the wireless communication of the streaming data with the specific terminal stored in the storage unit via a newly constructed wireless network and wireless communication of data with the third terminal via a newly constructed wireless network according to the ratio set by the communication-setting unit.

According to a thirteenth aspect of the present invention, in the wireless communication terminal of the twelfth aspect, the communication-setting unit may set the ratio of data communication performed along with the specific terminal stored in the storage unit to a value larger than “0” and set the ratio of data communication performed along with the third terminal to “0.”

According to a fourteenth aspect of the present invention, in the wireless communication terminal of the first aspect, when the participation request is received, the estimating unit may estimate whether or not the first terminal is to perform the wireless communication of the streaming data based on information included in the frame of the participation request and information transmitted before the first terminal that has made the participation request makes the participation request.

According to a fifteenth aspect of the present invention, in the wireless communication terminal of the first aspect, after the first terminal that has made the participation request participates in the wireless network constructed by the network-constructing unit, when information representing reproduction capability of streaming data used for streaming of content or information representing a kind of streaming data supported by the first terminal is received from the first terminal, the estimating unit may estimate whether or not the first terminal is to perform the wireless communication of the streaming data based on the information.

According to a sixteenth aspect of the present invention, in the wireless communication terminal of the first aspect, after wireless communication with a terminal other than the specific terminal stored in the storage unit is released, the wireless communication unit may perform the wireless communication of the streaming data with the specific terminal stored in the storage unit via a wireless network newly constructed by the specific terminal.

According to a seventeenth aspect of the present invention, in the wireless communication terminal of the first aspect, when a plurality of second terminals are participating in the wireless network constructed by the network-constructing unit, the communication release unit may disconnect a connection with all of the second terminals, and after the connection with all of the second terminals is disconnected, the wireless communication unit may establish a connection with the specific terminal stored in the storage unit, and performs the wireless communication of the streaming data with the specific terminal.

According to an eighteenth aspect of the present invention, a wireless communication system includes a wireless communication terminal including a network-constructing unit that constructs a wireless network, a receiving unit that receives a participation request from a first terminal that is not participating in the wireless network constructed by the network-constructing unit, an estimating unit that estimates whether or not the first terminal is to perform wireless communication of streaming data used for streaming of content based on information received from the first terminal when the participation request is received, a storage unit that stores the first terminal as a specific terminal when it is estimated that the first terminal is to perform the wireless communication of the streaming data, a communication release unit that performs a process of releasing wireless communication with a second terminal that is participating in the wireless network constructed by the network-constructing unit when it is estimated that the first terminal is to perform the wireless communication of the streaming data, and a wireless communication unit that performs the wireless communication of the streaming data with the specific terminal stored in the storage unit after the wireless communication with the second terminal is released, and the specific terminal that wirelessly transmits the participation request, and performs the wireless communication of the streaming data with the wireless communication terminal.

According to a nineteenth aspect of the present invention, a wireless communication method is performed by a wireless communication terminal including a network-constructing unit that constructs a wireless network, a storage unit that stores information, and a wireless communication unit that performs wireless communication, and includes receiving a participation request from a first terminal that is not participating in the wireless network constructed by the network-constructing unit, estimating whether or not the first terminal is to perform wireless communication of streaming data used for streaming of content based on information received from the first terminal when the participation request is received, storing the first terminal as a specific terminal in the storage unit when the first terminal is estimated to perform the wireless communication of the streaming data, performing a process of releasing wireless communication with a second terminal that is participating in the wireless network constructed by the network-constructing unit when the first terminal is estimated to perform the wireless communication of the streaming data, and performing the wireless communication of the streaming data with the specific terminal stored in the storage unit after the wireless communication with the second terminal is released.

According to a twentieth aspect of the present invention, a computer-readable storage device storing a program executed by a computer of a wireless communication terminal including a network-constructing unit that constructs a wireless network, a storage unit that stores information, and a wireless communication unit, the program causing the computer to execute receiving a participation request from a first terminal that is not participating in the wireless network constructed by the network-constructing unit, estimating whether or not the first terminal is to perform wireless communication of streaming data used for streaming of content based on information received from the first terminal when the participation request is received, storing the first terminal as a specific terminal in the storage unit when first the terminal is estimated to perform the wireless communication of the streaming data, performing a process of releasing wireless communication with a second terminal that is participating in the wireless network constructed by the network-constructing unit when the first terminal is estimated to perform the wireless communication of the streaming data, and performing the wireless communication of the streaming data with the specific terminal stored in the storage unit after the wireless communication with the second terminal is released.

### BRIEF DESCRIPTION OF THE DRAWINGS

FIG. 1 is a block diagram illustrating a constitution of a video communication terminal according to a first embodiment of the present invention;

FIG. 2 is a flowchart illustrating an operation process of a video communication terminal according to the first embodiment of the present invention;

FIG. 3 is a flowchart illustrating an operation process of a video communication terminal according to the first embodiment of the present invention;

FIG. 4 is a sequence diagram illustrating a communication process performed by a video communication terminal and a wireless communication terminal according to the first embodiment of the present invention;

FIG. 5 is a flowchart illustrating an operation process of a video communication terminal according to the first embodiment of the present invention;

FIG. 6 is a sequence diagram illustrating a communication process performed by a video communication terminal and a wireless communication terminal according to the first embodiment of the present invention;

FIG. 7 is a flowchart illustrating an operation process of a video communication terminal according to the first embodiment of the present invention;

FIG. 8 is a sequence diagram illustrating a communication process performed by a video communication terminal and a wireless communication terminal according to the first embodiment of the present invention;

FIG. 9 is a flowchart illustrating an operation process of a video communication terminal according to the first embodiment of the present invention;

FIG. 10 is a flowchart illustrating an operation process of a video communication terminal according to the first embodiment of the present invention;

FIG. 11 is a sequence diagram illustrating a communication process performed by a video communication terminal and a wireless communication terminal according to the first embodiment of the present invention;

FIG. 12 is a block diagram illustrating a constitution of a video communication terminal according to a second embodiment of the present invention;

FIG. 13 is a flowchart illustrating an operation process of a video communication terminal according to the second embodiment of the present invention;

FIG. 14 is a sequence diagram illustrating a communication process performed by a video communication terminal and a wireless communication terminal according to the second embodiment of the present invention;

FIG. 15 is a block diagram illustrating a constitution of a video communication terminal according to a third embodiment of the present invention;

FIG. 16 is a flowchart illustrating an operation process of a video communication terminal according to the third embodiment of the present invention;

FIG. 17 is a sequence diagram illustrating a communication process performed by a video communication terminal and a wireless communication terminal according to the third embodiment of the present invention;

FIG. 18 is a flowchart illustrating an operation process of a video communication terminal according to a fourth embodiment of the present invention;

FIG. 19 is a sequence diagram illustrating a communication process performed by a video communication terminal and a wireless communication terminal according to the fourth embodiment of the present invention;

FIG. 20 is a flowchart illustrating an operation process of a video communication terminal according to a fifth embodiment of the present invention;

FIG. 21 is a sequence diagram illustrating a communication process performed by a video communication terminal and a wireless communication terminal according to the fifth embodiment of the present invention;

FIG. 22 is a flowchart illustrating an operation process of a video communication terminal according to a sixth embodiment of the present invention; and

FIG. 23 is a sequence diagram illustrating a communication process performed by a video communication terminal and a wireless communication terminal according to the sixth embodiment of the present invention.

### DETAILED DESCRIPTION OF THE INVENTION

Hereinafter, exemplary embodiments of the present invention will be described with reference to the accompanying drawings. It is obvious to a person skilled in the art, based on the present disclosure, that the embodiments of the present invention which will described below are merely to concretely describe inventions and equivalents thereof set forth in the appended claims and not intended to limit inventions and equivalents thereof set forth in the appended claims.

### First Embodiment

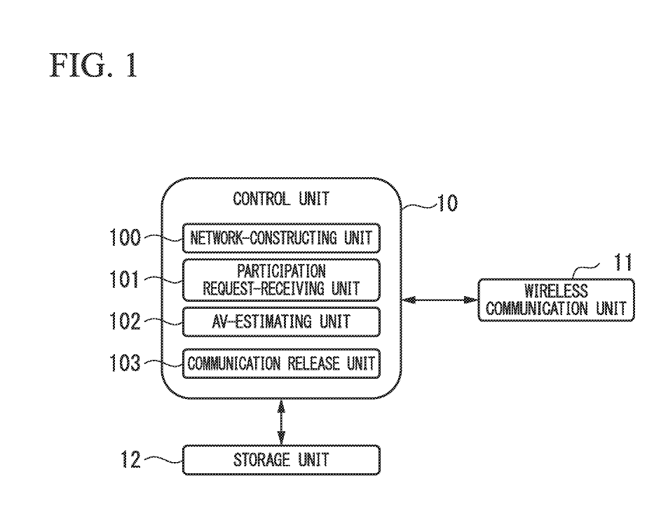

First of all, a first embodiment of the present invention will be described. FIG. 1 illustrates a constitution of a video communication terminal according to the present embodiment. A video communication terminal illustrated in FIG. 1 includes a control unit 10, a wireless communication unit 11, and a storage unit 12.

The control unit 10 controls the wireless communication unit 11. The control unit 10 includes a network-constructing unit 100, a participation request-receiving unit 101, an audio video-estimating unit (AV estimating unit) 102, and a communication release unit 103. The network-constructing unit 100 constructs a network (wireless network) in which wireless communication is performed. The participation request-receiving unit 101 receives a participation request for the network constructed by the network-constructing unit 100 from a terminal that is not yet participating in the network. When the participation request is received from the other terminal, the AV-estimating unit 102 estimates whether or not the corresponding terminal is to perform wireless AV data communication based on information received from the corresponding terminal. When the AV-estimating unit 102 estimates that the terminal that has made the participation request is to perform wireless AV data communication, the corresponding terminal is stored in the storage unit 12 as a specific terminal. AV data of the present embodiment is streaming data including either or both of audio data and video data. When it is estimated that the terminal that has made the participation request is to perform wireless AV data communication, the communication release unit 103 performs a process of releasing wireless communication with a terminal that is participating in the network constructed by the network-constructing unit 100.

The wireless communication unit 11 performs wireless communication with the other terminal. The wireless communication unit 11 performs wireless AV data communication with the specific terminal stored in the storage unit 12 after wireless communication is released by the communication release unit 103. The storage unit 12 stores AV data, information identifying the specific terminal, a program specifying an operation of the control unit 10, various kinds of information used for processing of the control unit 10, and the like. The storage unit 12 may include either of a non-volatile memory and a volatile memory. Further, the storage unit 12 may include both of a non-volatile memory and a volatile memory.

For example, a function of the control unit 10 is implemented such that a computer (CPU) of the video communication terminal reads and executes a program stored in the storage unit 12. For example, the program may be provided by a “computer-readable storing medium” such as a flash memory. The program may be input to the video communication terminal such that the program is transmitted to the video communication terminal from a computer in which the program is stored in a memory device or the like through a transmission medium or a transmission wave of a transmission medium. Here, the “transmission medium” transmitting the program is a medium having a function of transmitting information such as a network (communication network) such as the Internet or a communication line such as a telephone line. Further, the program may be one which implements part of the above-described function. Further, the program may be one which implements the above-described function in combination with a program stored in a computer in advance or a differential file (differential program).

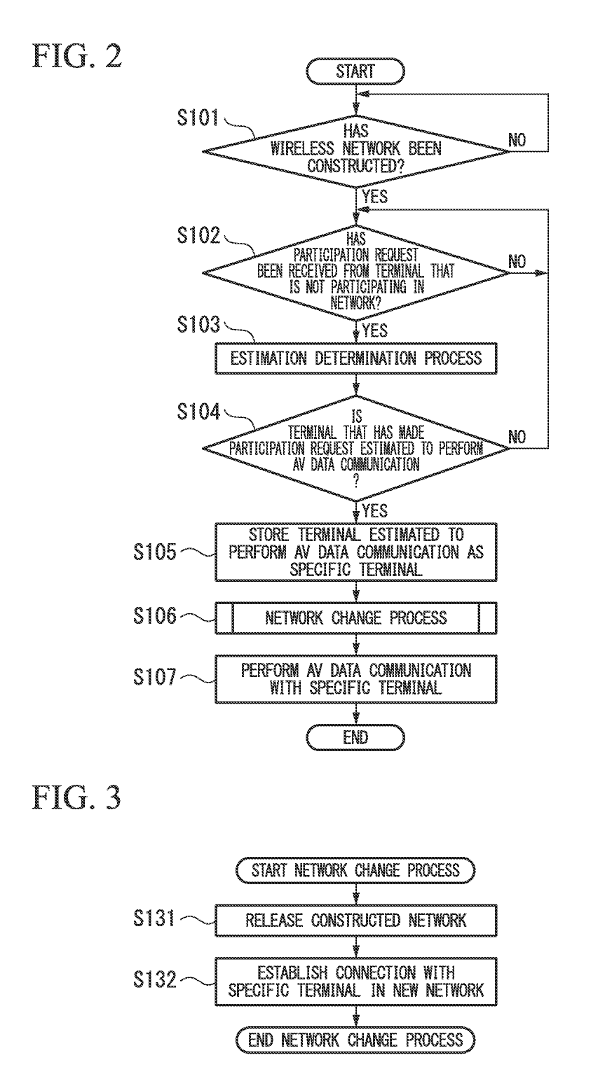

FIG. 2 illustrates an operation of the video communication terminal. An operation of the video communication terminal will be described with reference to FIG. 2.

For example, an operation illustrated in FIG. 2 starts as the video communication terminal is powered on or as a setting for activating wireless communication is performed based on the user's instruction in a state in which the video communication terminal is powered on. First of all, the network-constructing unit 100 determines whether or not a network has already been constructed (whether network construction is completed) (step S101). The network construction is performed such that an SSID serving as a network identifier and a passphrase serving as an encryption key are generated and stored in the storage unit 12.

When the network is constructed, the video communication terminal starts transmission of a beacon frame, reception of a frame of a participation request from another terminal, and transmission of a response frame to the frame of the received participation request. When the network is constructed, the network-constructing unit 100 stores information representing that the network is constructed in the storage unit 12. In step S101, the determination is performed based on this information.

When the network is not constructed, the determination of step S101 is repeatedly performed until the network is constructed. When the network is constructed, the participation request-receiving unit 101 determines whether or not the participation request has been received from the terminal that is not participating in the constructed network (step S102). The reception of the participation request is performed such that the frame of the participation request is received through the wireless communication unit 11. For example, the frame of the participation request is an association request frame but may be a frame having a distinctive format.

When the participation request is not received, the determination of step S102 is repeatedly performed until the participation request is received. When the participation request is received, the AV-estimating unit 102 performs an estimation determination process of estimating whether or not the terminal that has made the participation request is to perform wireless AV data communication (step S103). Then, the AV-estimating unit 102 determines whether or not it is estimated that the terminal that has made the participation request is to perform wireless AV data communication based on the result obtained by the estimation determination process in step S103 (step S104).

When it is estimated that the terminal that has made the participation request is not to perform wireless AV data communication, the process of step S102 is performed. When it is estimated that the terminal that has made the participation request is to perform wireless AV data communication, the AV-estimating unit 102 performs the following process. The AV-estimating unit 102 stores information identifying a terminal (hereinafter referred to as a “specific terminal”) that is the terminal that has made the participation request and is estimated as performing wireless AV data communication in the storage unit 12 (step S105).

Thereafter, a network change process of changing a constitution of the network is performed (step S106). FIG. 3 illustrates detailed content of the network change process. First of all, the communication release unit 103 releases the network constructed by the network-constructing unit 100 (step S131). In step S131, transmission of a beacon frame, reception of a frame of a participation request from another terminal, and transmission of a response frame to the frame of the received participation request are stopped. Thereafter, the communication release unit 103 establishes a connection with the specific terminal represented by the information stored in the storage unit 12 via a newly constructed network after the network is released in step S131 (step S132). Then, the network change process ends.

The network used to establish a connection with the specific terminal in step S132 may be a network constructed by the network-constructing unit 100 after the network is released in step S131. Further, the network used to establish a connection with the specific terminal in step S132 may be a network constructed by the specific terminal after the network is released in step S131. The SSID and the passphrase used in the network released in step S131 and those used in a network newly constructed thereafter are preferably different but may be the same.

When the network change process ends, the wireless communication unit 11 performs wireless AV data communication with the specific terminal connected in step S132 (step S107). In wireless AV data communication performed in step S107, AV data may be wirelessly transmitted from the video communication terminal to the specific terminal, and AV data may be wirelessly transmitted from the specific terminal to the video communication terminal.

When wireless AV data communication in step S107 ends, the video communication terminal ends the process. After wireless AV data communication ends, wireless communication of data other than AV data may be performed, wireless AV data communication may be resumed, or the process of step S102 may be performed again.

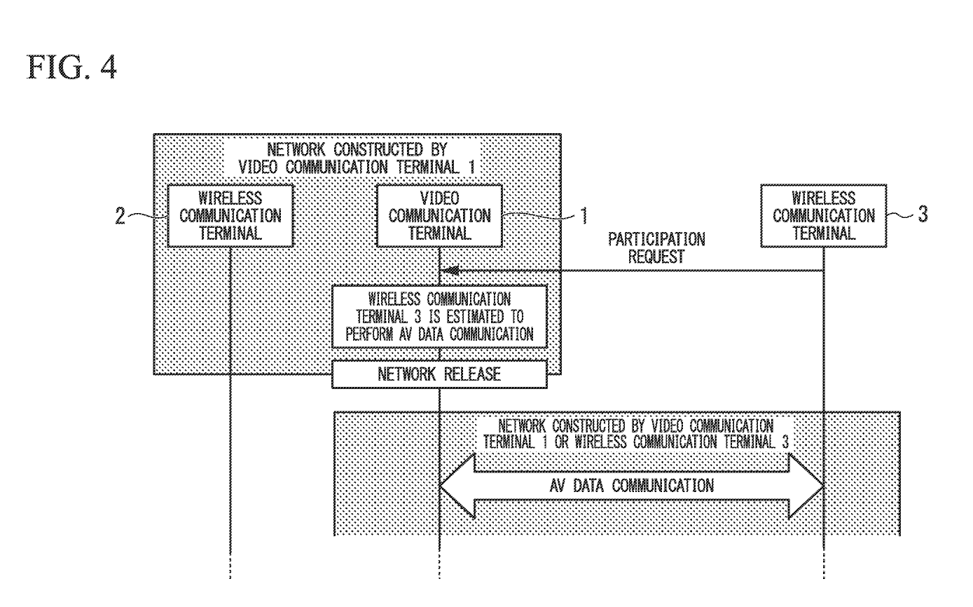

FIG. 4 illustrates an example in which the video communication terminal performs the operation illustrated in FIGS. 2 and 3. As illustrated in FIG. 4, in a wireless communication system including a video communication terminal 1 and wireless communication terminals 2 and 3, in the initial state, only the wireless communication terminal 2 is participating in a network constructed by the video communication terminal 1 and is performing data communication with the video communication terminal 1. When the participation request from the wireless communication terminal 3 is received, the video communication terminal 1 estimates that the wireless communication terminal 3 is to perform wireless AV data communication (corresponding to steps S103 and S104). Then, the video communication terminal 1 releases the network the video communication terminal 1 has constructed (corresponding to step S131). After the network is released, the video communication terminal 1 performs wireless AV data communication with the wireless communication terminal 3 via a network the video communication terminal 1 or the wireless communication terminal 3 has constructed (corresponding to step S107).

Next, a modified example of the present embodiment will be described. Three kinds of modified examples will be described below.

### First Modified Example

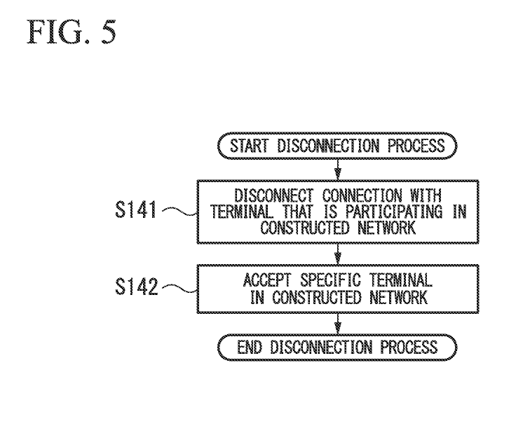

The video communication terminal may perform a disconnection process illustrated in FIG. 5 instead of the network change process in step S106. After the information identifying the specific terminal is stored in the storage unit 12 in step S105, the communication release unit 103 performs a process of disconnecting a connection with a terminal that is participating in the network constructed by the network-constructing unit 100 (step S141). In step S141, for example, a disassociation frame is transmitted to the terminal that is participating in the network constructed by the network-constructing unit 100 through the wireless communication unit 11. Further, in step S141, a frame having a distinctive format may be transmitted instead of the disassociation frame.

Thereafter, the communication release unit 103 performs a process of accepting the specific terminal represented by the information stored in the storage unit 12 in the network constructed by the network-constructing unit 100 (step S142). In step S142, for example, a response frame (for example, an association response frame) used to perform the acceptance is transmitted to the specific terminal from which the participation request has been received in step S102 through the wireless communication unit 11. Further, in step S142, information of the accepted specific terminal is stored in the storage unit 12. When the participation request received in step S102 is based on a frame having a distinctive format rather than the association request frame, the response frame may not be transmitted in step S142. In this case, the information of the accepted specific terminal may be stored in the storage unit 12. Then, the disconnection process ends.

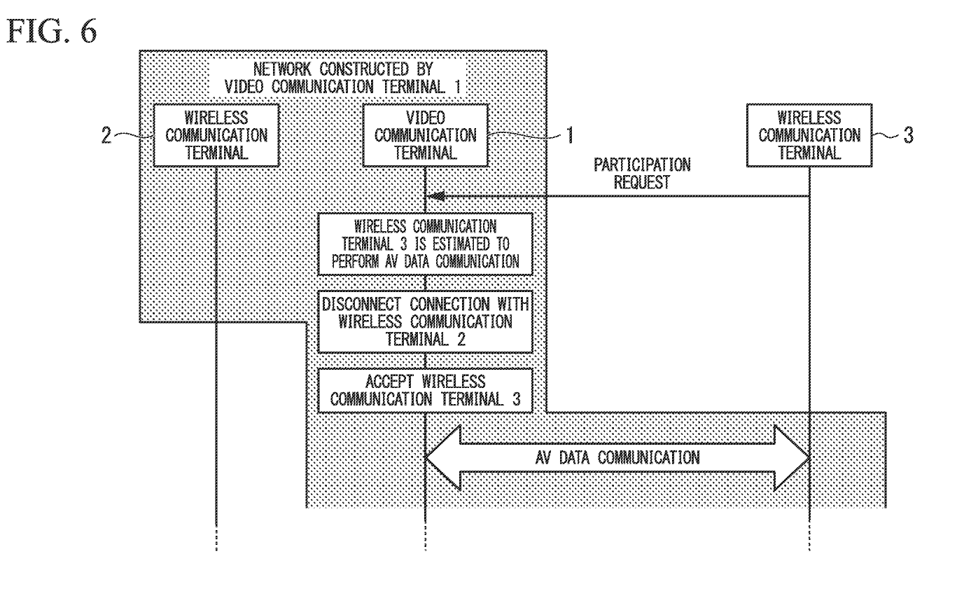

FIG. 6 illustrates an example in which the video communication terminal performs the operation illustrated in FIG. 5. As illustrated in FIG. 6, in the wireless communication system including the video communication terminal 1 and the wireless communication terminals 2 and 3, in the initial state, only the wireless communication terminal 2 is participating in a network constructed by the video communication terminal 1 and is performing data communication with the video communication terminal 1. When the participation request from the wireless communication terminal 3 is received, the video communication terminal 1 estimates that the wireless communication terminal 3 is to perform wireless AV data communication (corresponding to steps S103 and S104). Then, the video communication terminal 1 disconnects the connection with the wireless communication terminal 2 that is participating in the network the video communication terminal 1 has constructed (corresponding to step S141). After the connection with the wireless communication terminal 2 is disconnected, the video communication terminal 1 accepts the wireless communication terminal 3 in the network constructed by the network-constructing unit 100 (corresponding to step S142). Then, the video communication terminal 1 performs wireless AV data communication with the wireless communication terminal 3 (corresponding to step S107).

### Second Modified Example

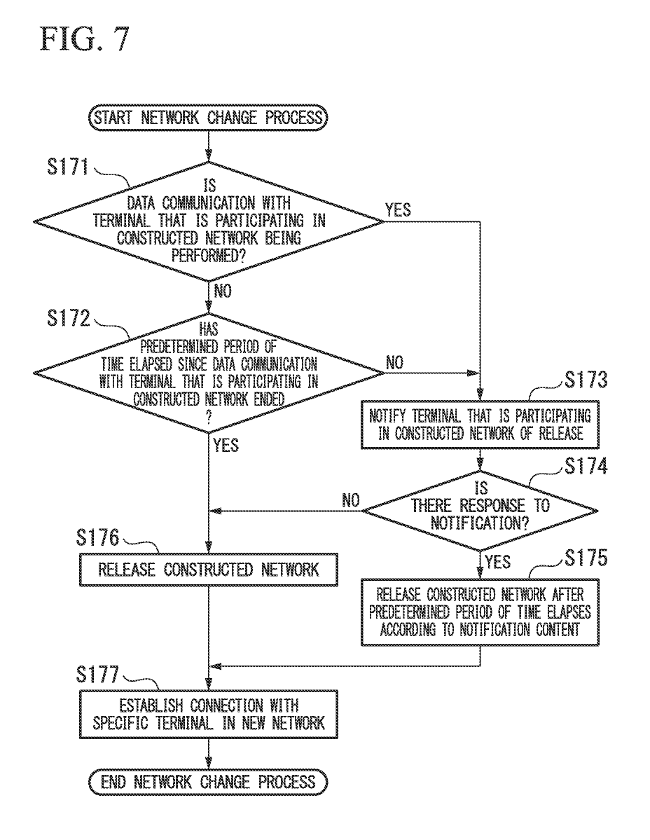

FIG. 7 illustrates another example of the network change process in step S106. After the information identifying the specific terminal is stored in the storage unit 12 in step S105, the communication release unit 103 performs the following process. The communication release unit 103 determines whether or not data communication with the terminal that is participating in the network constructed by the network-constructing unit 100 is being performed (step S171). In step S171, it is determined that data communication is being performed when a state of communication is a state between when a connection of communication by a protocol such as a transmission control protocol (TCP) or a hypertext transfer protocol (HTTP) starts and when the connection ends. Alternatively, in step S171, it may be determined that data communication is being performed when a state of communication is a state between when the user instructs the start of data communication and when the user instructs the end of data communication in the case in which the user can instruct the start and the end of data communication.

When it is determined that data communication is being performed, the process proceeds to step S173. Further, when it is determined that data communication is not being performed, the communication release unit 103 determines whether or not a predetermined period of time elapses after data communication with the terminal that is participating in the network constructed by the network-constructing unit 100 ends (step S172). For example, a timing at which data communication ends is a timing at which a connection of communication by a protocol such as a TCP or a HTTP ends or a timing at which the user instructs the end of data communication. When it is determined that a predetermined period of time does not elapse after data communication ends, the process proceeds to step S173. Further, when it is determined that a predetermined period of time elapses after data communication ends, the communication release unit 103 releases the network constructed by the network-constructing unit 100 (step S176). In step S176, transmission of a beacon frame, reception of a frame of a participation request from another terminal, and transmission of a response frame to the frame of the received participation request are stopped.

Thereafter, the communication release unit 103 establishes a connection with the specific terminal represented by the information stored in the storage unit 12 via a network newly constructed after the network is released in step S176 (step S177). Then, the network change process ends.

The network used to establish the connection with the specific terminal in step S177 may be a network constructed by the network-constructing unit 100 after the network is released in step S176. Further, the network used to establish the connection with the specific terminal in step S177 may be a network constructed by the specific terminal after the network is released in step S176. The SSID and the passphrase used in the network released in step S176 and those used in a network newly constructed thereafter are preferably different but may be the same.

When it is determined in step S171 that data communication is being performed or when it is determined in step S172 that a predetermined period of time does not elapse after data communication ends, the communication release unit 103 performs the following process. In this case, the communication release unit 103 transmits a frame for notifying of the fact that the network is to be released to a terminal that is participating in the constructed network through the wireless communication unit 11 (step S173). Thereafter, the communication release unit 103 determines whether or not there is a response to the frame transmitted in step S173 (step S174).

When it is determined that there is no response, the process proceeds to step S176. However, when it is determined that there is a response, the communication release unit 103 releases the network constructed by the network-constructing unit 100 after a predetermined period of time elapses according to content of a frame received as a response (step S175). In step S175, transmission of a beacon frame, reception of a frame of a participation request from another terminal, and transmission of a response frame to the frame of the received participation request are stopped.

When a period of time (for example, a period of time until the network is released after the response is received) for releasing the network is designated by the frame received as the response, the process proceeds to step S175. In step S175, after the designated period of time elapses, the communication release unit 103 releases the network. When a period of time for releasing the network is not designated by the frame received as the response, in step S175, the communication release unit 103 immediately releases the network. Thereafter, the process proceeds to step S177.

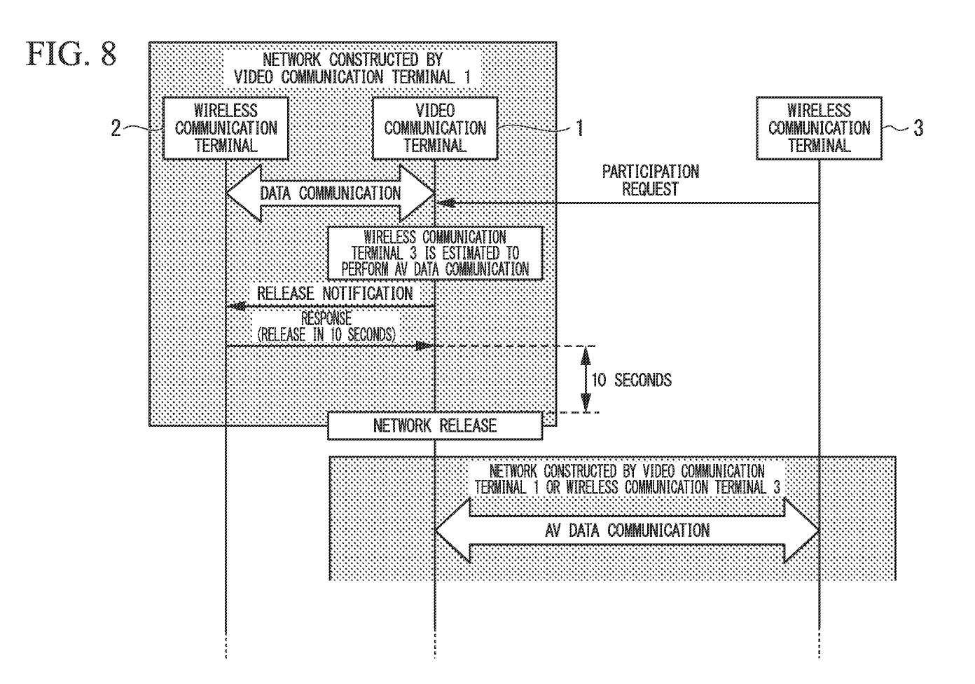

FIG. 8 illustrates an example in which the video communication terminal performs the operation illustrated in FIG. 7. As illustrated in FIG. 8, in the wireless communication system including the video communication terminal 1 and the wireless communication terminals 2 and 3, in the initial state, only the wireless communication terminal 2 is participating in a network constructed by the video communication terminal 1 and is performing data communication with the video communication terminal 1. When the participation request from the wireless communication terminal 3 is received, the video communication terminal 1 estimates that the wireless communication terminal 3 is to perform wireless AV data communication (corresponding to steps S103 and S104). Thereafter, the video communication terminal 1 transmits a frame for notifying the wireless communication terminal 2 that is participating in the network the video communication terminal 1 has constructed of the fact that the network is to be released (corresponding to step S173).

When the frame is received from the video communication terminal 1, the wireless communication terminal 2 transmits a frame to the video communication terminal 1 for notifying that the network will be released, for example, in 10 seconds as the response.

The wireless communication terminal 2 may perform the process of notifying the user of the fact that the network is to be released. When the frame is received from the wireless communication terminal 2 (corresponding to step S174), the video communication terminal 1 releases the network the video communication terminal 1 has constructed after the 10 seconds designated by the frame (corresponding to step S175). After the network is released, the video communication terminal 1 performs wireless AV data communication with the wireless communication terminal 3 via the network that the video communication terminal 1 or the wireless communication terminal 3 has constructed (corresponding to step S107).

### Third Modified Example

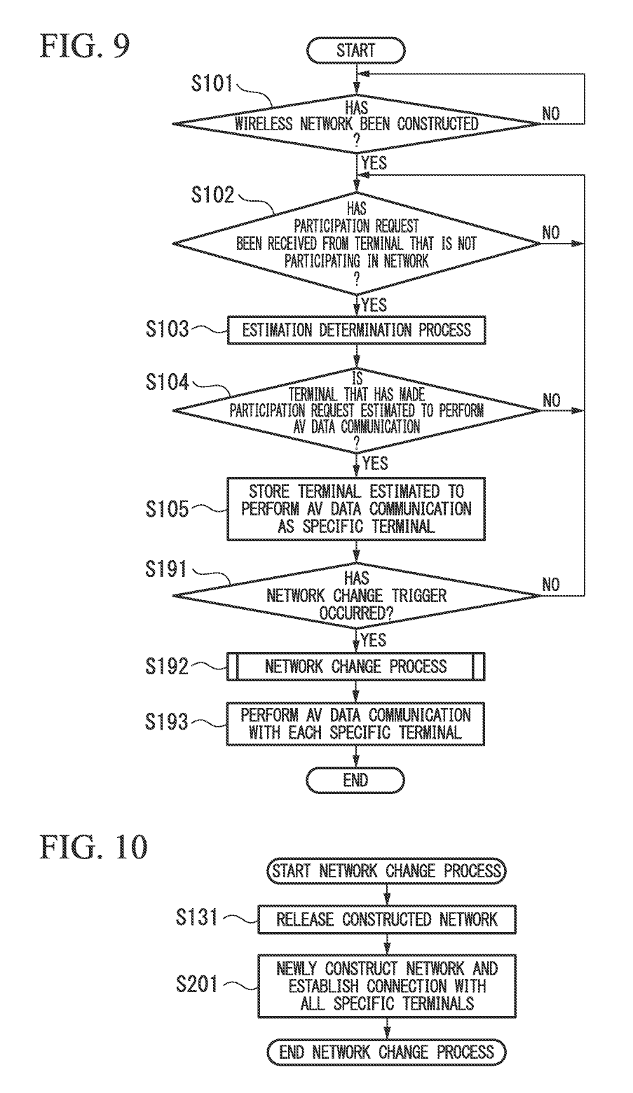

FIG. 9 illustrates another example of the process illustrated in FIG. 2. The process of steps S101 to S105 is the same as the process of steps S101 to S105 illustrated in FIG. 2, and thus a description thereof will not be repeated.

After the information identifying the specific terminal is stored in the storage unit 12 in step S105, the communication release unit 103 determines whether or not a network change trigger has occurred (step S191). For example, the network change trigger is an AV data communication start instruction from the user. In other words, when the AV data communication start instruction is given by the user, the network change trigger occurs. Alternatively, for example, the network change trigger indicates that a predetermined period of time elapses after first information of the specific terminal is stored in the storage unit 12 in step S105. In other words, the network change trigger occurs when a predetermined period of time elapses after first information of the specific terminal is stored in the storage unit 12 in step S105. Alternatively, for example, the network change trigger indicates that preparation for performing wireless AV data communication with any one specific terminal is completed. In other words, the network change trigger occurs when preparation for performing wireless AV data communication with any one specific terminal is completed. The preparation for performing wireless AV data communication means transmission and reception of information related to AV data of a communication target, communication capability, or information related to display capability of the video-reproducing terminal. The network change triggers are exemplary, and any other network change trigger may be used.

When it is determined that the network change trigger has not occurred, the process proceeds to step S102. The process of steps S102 to S105 is repeatedly performed until the network change trigger occurs, and a plurality of specific terminals may be detected. When it is determined that the network change trigger has occurred, the network change process for changing the network constitution is performed (step S192).

FIG. 10 illustrates detailed content of the network change process. First of all, the communication release unit 103 releases the network constructed by the network-constructing unit 100 (step S131). In step S131, transmission of a beacon frame, reception of a frame of a participation request from another terminal, and transmission of a response frame to the frame of the received participation request are stopped. Thereafter, the communication release unit 103 causes the network-constructing unit 100 to construct a new network. After the network-constructing unit 100 constructs a new network, the communication release unit 103 establishes connections with all specific terminals represented by information stored in the storage unit 12 through the newly constructed network (step S201). When pieces of information of a plurality of specific terminals are stored in the storage unit 12, in step S201, the communication release unit 103 establishes connections with the plurality of specific terminals. Then, the network change process ends.

When the network change process ends, the wireless communication unit 11 performs wireless AV data communication with the specific terminal connected in step S201 (step S193). In wireless AV data communication performed in step S193, for example, AV data is wirelessly transmitted from the video communication terminal to the plurality of specific terminals in the multicast or broadcast manner. Further, in wireless AV data communication performed in step S193, for example, the wireless communication unit 11 may transmit video data to some (for example, televisions) of the plurality of specific terminals. In this case, the wireless communication unit 11 may transmit audio data to specific terminals (for example, speakers) other than the specific terminals to which video data has been transmitted among the plurality of specific terminals.

When wireless AV data communication in step S193 ends, the video communication terminal ends the process. Further, after wireless AV data communication ends, the video communication terminal may perform wireless communication of data other than AV data, may resume wireless AV data communication, and may perform the process of step S102 again.

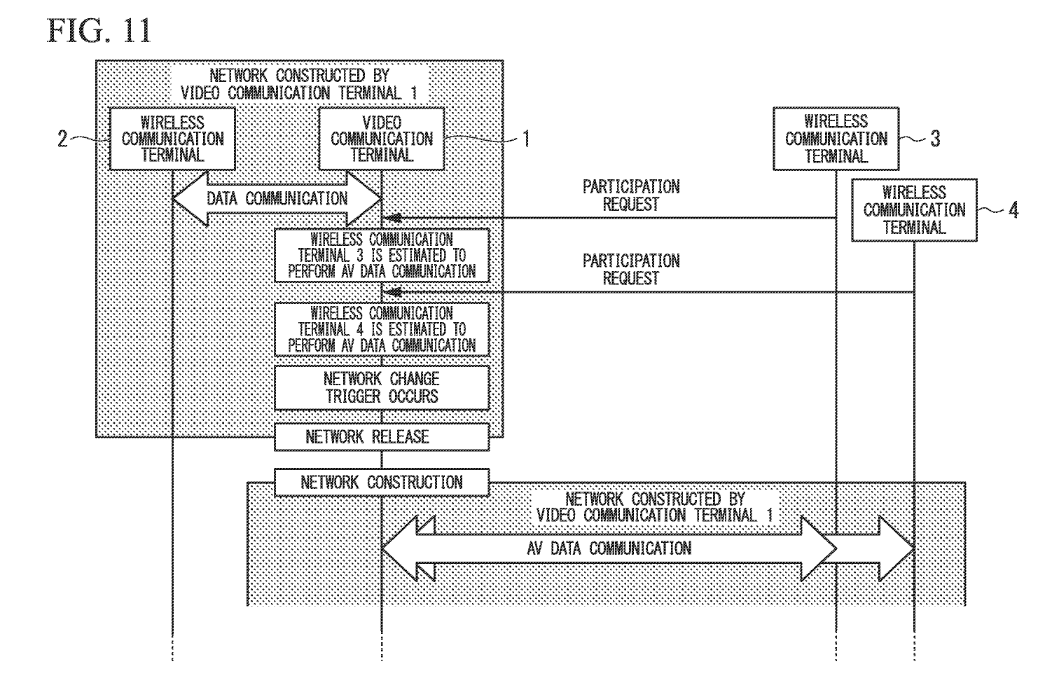

FIG. 11 illustrates an example in which the video communication terminal performs the operation illustrated in FIGS. 9 and 10.

As illustrated in FIG. 11, in a wireless communication system including a video communication terminal 1 and wireless communication terminals 2 to 4, in the initial state, only the wireless communication terminal 2 is participating in a network constructed by the video communication terminal 1 and is performing data communication with the video communication terminal 1. Upon receiving the participation requests from the wireless communication terminals 3 and 4, the video communication terminal 1 estimates that each of the wireless communication terminals 3 and 4 is to perform wireless AV data communication (corresponding to steps S103 and S104). Thereafter, when the network change trigger occurs (corresponding to step S191, the video communication terminal 1 releases the network the video communication terminal 1 has constructed (corresponding to step S131). After the network is released, the video communication terminal 1 newly constructs a network (corresponding to step S201), and performs wireless AV data communication with the wireless communication terminals 3 and 4 via the constructed network (corresponding to step S193).

In the first embodiment, the video communication terminal corresponds to a wireless communication terminal of a top concept in the present invention. For example, the wireless communication terminal of the present invention can be configured such that the network-constructing unit 100 is used as a network-constructing unit in the wireless communication terminal of the present invention, the participation request-receiving unit 101 is used as a receiving unit in the wireless communication terminal of the present invention, the AV-estimating unit 102 is used as an estimating unit in the wireless communication terminal of the present invention, the communication release unit 103 is used as a communication release unit in the wireless communication terminal of the present invention, and the wireless communication unit 11 is used as a wireless communication unit in the wireless communication terminal of the present invention.

According to the present embodiment, when the participation request is received from a terminal that is not participating in a network constructed by the video communication terminal, it is estimated whether or not the terminal is to perform wireless AV data communication. Then, when it is estimated that wireless AV data communication is to be performed, a process of releasing wireless communication with the terminal that is participating in the network constructed by the video communication terminal is performed. Further, after wireless communication is released, wireless AV data communication is performed between the video communication terminal and the specific terminal. Thus, the video communication terminal can avoid or reduce deterioration in the quality of wireless communication which is caused due to influence of wireless communication performed by a terminal other than a specific terminal on wireless AV data communication.

Further, a notification representing that the network is to be released is given to a terminal that is participating in the network at a timing during data communication (step S171) or a timing within a predetermined period of time after data communication ends (step S172). Through this operation, the video communication terminal can prevent the terminal from performing a useless process such as a process of transmitting the participation request to the released network again after the network is released since the terminal does not know that the network has been released.

Further, when a period of time for releasing the network is designated by a response frame to a frame for notifying that the network is to be released, the network is released at a timing according to the designated period of time. Through this operation, the video communication terminal can release the network at a timing according to a situation of a terminal side that is participating in the network. For example, when the terminal participating in the network is performing data communication and desires a standby operation until data communication ends, the video communication terminal can release the network after data communication ends.

### Second Embodiment

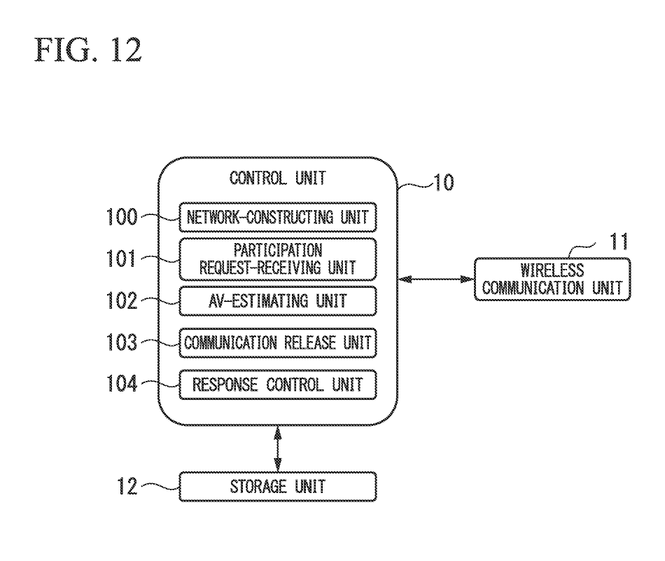

Next, a second embodiment of the present invention will be described. FIG. 12 illustrates a constitution of a video communication terminal according to the present embodiment. The video communication terminal illustrated in FIG. 12 is configured differently from that illustrated in FIG. 1 in that a response control unit 104 is added to the control unit 10. When the participation request is received from a terminal that is not participating in the network constructed by the network-constructing unit 100, the response control unit 104 performs the following process. In this case, the response control unit 104 performs control such that participation in the network is rejected when the number of terminals that are participating in the network is a predetermined limit number or more. The remaining constitution excluding the response control unit 104 is the same as described in the first embodiment, and thus a description thereof will not be repeated.

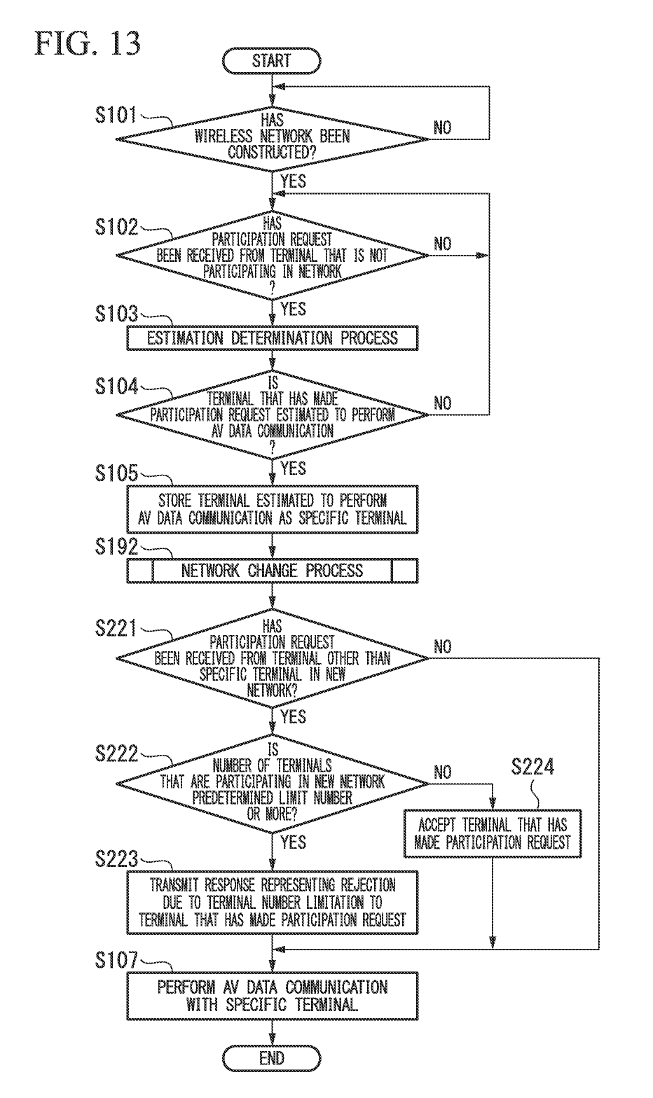

FIG. 13 illustrates an operation of the video communication terminal. An operation of the video communication terminal will be described with reference to FIG. 13. The process of steps S101 to S105 is the same as the process of steps S101 to S105 illustrated in FIG. 2, and thus a description thereof will not be repeated. Further, the process of step S192 is the same as the process illustrated in FIG. 10, and thus a description thereof will not be repeated.

When the network change process in step S192 ends, the participation request-receiving unit 101 performs the following process. The participation request-receiving unit 101 determines whether or not the participation request has been received from a terminal that is not participating in a network newly constructed by the network-constructing unit 100 and that is not a specific terminal (step S221). The network newly constructed by the network-constructing unit 100 is the network constructed in step S201 of FIG. 10. In step S221, the participation request-receiving unit 101 determines whether or not a terminal of a transmission source of the frame of the participation request is a specific terminal stored in the storage unit 12 when the participation request is received.

When the participation request is not received from the terminal other than the specific terminal, the process proceeds to step S107. Further, when the participation request is received from the terminal other than the specific terminal, the response control unit 104 determines whether or not the number of terminals that are participating in the network newly constructed by the network-constructing unit 100 is a predetermined limit number or more (step S222). Information of the number of terminals that are participating in the network is stored in the storage unit 12 and updated according to a participation state of each terminal to the network. Further, information of a predetermined limit number is also stored in the storage unit 12. The predetermined limit number is not limited as long as the limit number is one or more. In step S222, the participation request-receiving unit 101 performs the determination based on the above-mentioned information.

When the number of terminals that are participating in the network is a predetermined limit number or more, the response control unit 104 transmits a frame representing that participation in the network is rejected through the wireless communication unit 11. The response control unit 104 transmits the frame representing the rejection to the terminal from which the participation request has been received in step S221 (step S223). In step S223, for example, an association response frame including error information is transmitted. Further, the frame transmitted in step S223 includes information representing the reason for rejecting participation, i.e., that the number of terminals that are participating in the network exceeds the predetermined limit number. As a modified example, in step S223, a response frame including no reason for rejecting participation may be transmitted, or a response frame may not be transmitted. Thereafter, the process proceeds to step S107.

When the number of terminals that are participating in the network is less than the predetermined limit number, the response control unit 104 performs a process of accepting the terminal that has made the participation request in the network constructed by the network-constructing unit 100 (step S224). In step S224, for example, a response frame (for example, an association response frame) representing the acceptance is transmitted to the terminal from which the participation request has been received in step S221 through the wireless communication unit 11. Then, information of the accepted terminal is stored in the storage unit 12. When the participation request received in step S221 is based on a frame having a distinctive format rather than the association request frame, the response control unit 104 may not transmit the response frame in step S224. Further, the response control unit 104 causes the information of the accepted terminal to be stored in the storage unit 12.

Thereafter, the process proceeds to step S107.

The process of step S107 is the same as the process of step S107 illustrated in FIG. 2, and thus a description thereof will not be repeated. When wireless AV data communication in step S107 ends, the video communication terminal ends the process. Further, after wireless AV data communication ends, wireless communication of data other than AV data may be performed, wireless AV data communication may be resumed, or the process of steps S221 to S224 may be performed again.

The terminal that has received the frame transmitted from the video communication terminal in step S223 may stop participating in the network constructed by the video communication terminal and make an attempt to participate in another network. Further, the terminal that has received the frame may attempt to participate in the network constructed by the video communication terminal again after a certain period of time elapses after the frame is received.

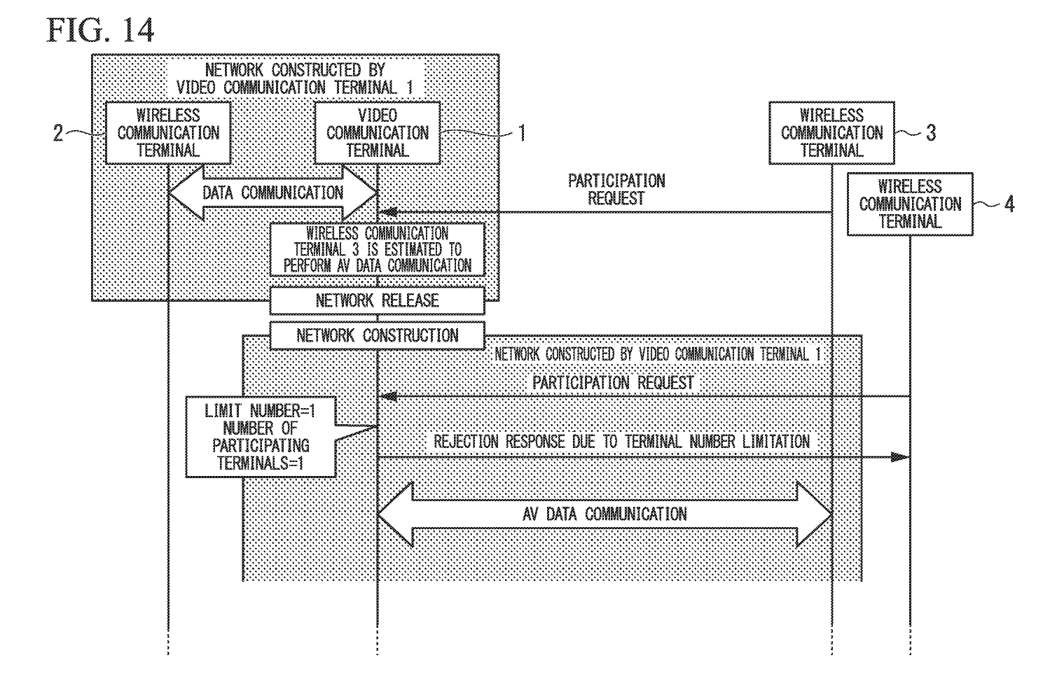

FIG. 14 illustrates an example in which the video communication terminal performs the operation illustrated in FIG. 13. As illustrated in FIG. 14, in a wireless communication system including a video communication terminal 1 and wireless communication terminals 2 to 4, in the initial state, only the wireless communication terminal 2 is participating in a network constructed by the video communication terminal 1 and is performing data communication with the video communication terminal 1. When the participation request from the wireless communication terminal 3 is received, the video communication terminal 1 estimates that the wireless communication terminal 3 is to perform wireless AV data communication (corresponding to steps S103 and S104). Thereafter, the video communication terminal 1 releases the network the video communication terminal 1 has constructed (corresponding to step S131). After the network is released, the video communication terminal 1 newly constructs a network (corresponding to step S201).

The wireless communication terminal 3 is accepted in the newly constructed network. In the example illustrated in FIG. 14, the limit number of terminals that can participate in the newly constructed network is 1.

When the wireless communication terminal 4 makes the participation request, the video communication terminal 1 transmits a frame representing that participation in the network is rejected to the wireless communication terminal 4 (corresponding to step S223). This is because the wireless communication terminal 3 is already participating in the network, and the limit number of terminals is 1. Thereafter, the video communication terminal 1 performs wireless AV data communication with the wireless communication terminal 3 via the constructed network (corresponding to step S107).

According to the present embodiment, the number of terminals that can participate in the newly constructed network is a predetermined limit number or less. Thus, it is possible to avoid or reduce deterioration in the quality of wireless communication which is caused due to influence of wireless communication performed by the terminal other than the specific terminal on wireless AV data communication performed by the specific terminal.

Further, a frame including information representing the reason for rejecting participation is transmitted to the terminal that has made the participation request for participating in the newly constructed network, and thus the terminal can be notified of the reason for rejecting participation. Further, it is possible to prevent the terminal from performing a useless process such as a process of transmitting the participation request for participating in the released network again.

### Third Embodiment

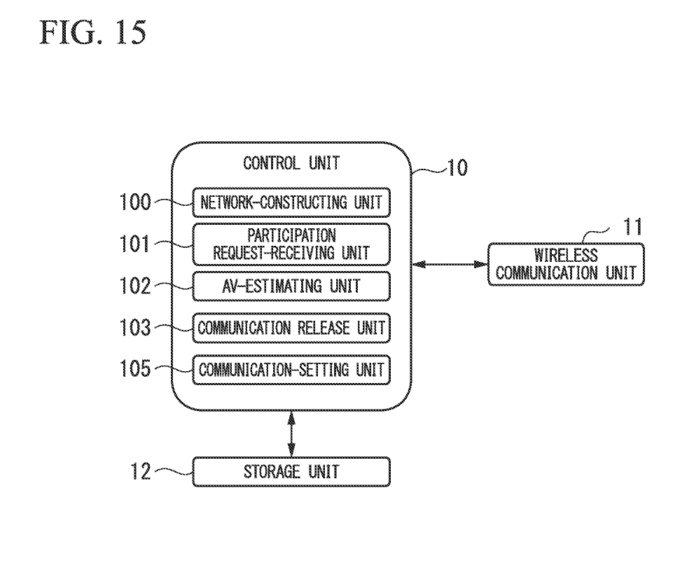

Next, a third embodiment of the present invention will be described. FIG. 15 illustrates a constitution of the video communication terminal according to the present embodiment. The video communication terminal illustrated in FIG. 15 is configured differently from that illustrated in FIG. 1 in that a communication-setting unit 105 is added to the control unit 10. The communication-setting unit 105 performs the following process after a network is newly constructed by the network-constructing unit 100. When the participation request is received from a terminal other than the specific terminal stored in the storage unit 12, the communication-setting unit 105 sets a ratio of data communication performed by the specific terminal stored in the storage unit 12 to be higher than a ratio of data communication performed by the terminal that has made the participation request. The remaining constitution excluding the communication-setting unit 105 is the same as described above in the first embodiment, and thus a description thereof will not be repeated.

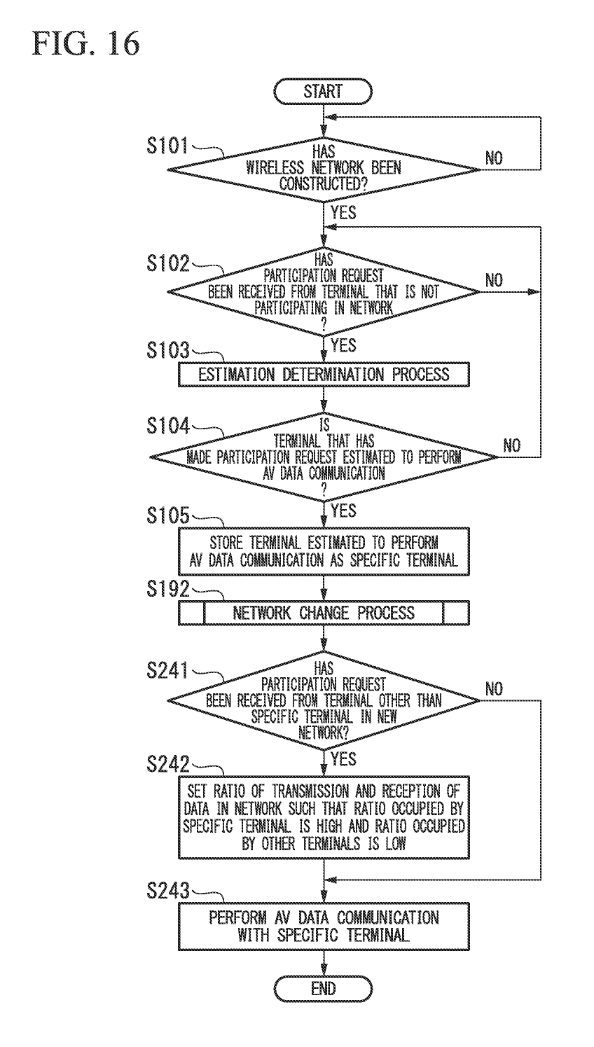

FIG. 16 illustrates an operation of the video communication terminal. An operation of the video communication terminal will be described with reference to FIG. 16. The process of steps S101 to S105 is the same as the process of steps S101 to S105 illustrated in FIG. 2, and thus a description thereof will not be repeated. Further, the process of step S192 is the same as the process illustrated in FIG. 10, and thus a description thereof will not be repeated.

When the network change process in step S192 ends, the participation request-receiving unit 101 determines whether or not the participation request has been received from a terminal that is not participating in a network newly constructed by the network-constructing unit 100 and that is not a specific terminal (step S241). For example, the network newly constructed by the network-constructing unit 100 is the network constructed in step S201 of FIG. 10. In step S241, when the participation request is received, the participation request-receiving unit 101 determines whether or not the terminal of the transmission source of the frame of the participation request is the specific terminal stored in the storage unit 12.

When the participation request is not received from the terminal other than the specific terminal, the process proceeds to step S243. Further, when the participation request is received from the terminal other than the specific terminal, the communication-setting unit 105 sets a parameter deciding a period of time allocated to data communication in the wireless communication unit 11 so that the ratio of data communication performed by the specific terminal for all data communication performed via the newly constructed network is higher than the ratio of data communication performed by the terminal other than the specific terminal for all data communication performed via the newly constructed network (step S242). Through this operation, for example, a period of time allocated to data communication with the specific terminal is longer than a period of time allocated to data communication with the terminal other than the specific terminal.

In step S242, the ratio of data communication performed by the terminal other than the specific terminal may be set to “0” so that no data communication is performed with the terminal other than the specific terminal at all. In this case, the ratio of data communication performed by the specific terminal is 100%. Further, the video communication terminal may not fix but change the ratio of data communication performed by the specific terminal and the ratio of data communication performed by the terminal other than the specific terminal as necessary. For example, the video communication terminal may set a lower limit value of the ratio of data communication performed by the specific terminal to be higher than an upper limit value of the ratio of data communication performed by the terminal other than the specific terminal. In this case, the video communication terminal may change the ratio of data communication performed by the specific terminal within a predetermined range of the lower limit value or more as necessary and may change the ratio of data communication performed by the terminal other than the specific terminal within a predetermined range of the upper limit value or less.

Thereafter, the wireless communication unit 11 performs wireless AV data communication with the specific terminal connected in step S201 of step S192 (step S243). In the wireless AV data communication performed in step S243, AV data may be wirelessly transmitted from the video communication terminal to the specific terminal, and AV data may be wirelessly transmitted from the specific terminal to the video communication terminal. Further, when it is determined in step S241 that the participation request has been received from the terminal other than the specific terminal, in step S243, data communication with the terminal other than the specific terminal is appropriately performed according to the ratio set in step S242.

When the wireless AV data communication in step S243 ends, the video communication terminal ends the process. Further, after the wireless AV data communication ends, the video communication terminal may perform wireless communication of data other than AV data, resume wireless AV data communication, or perform the process of steps S241 and S242 again.

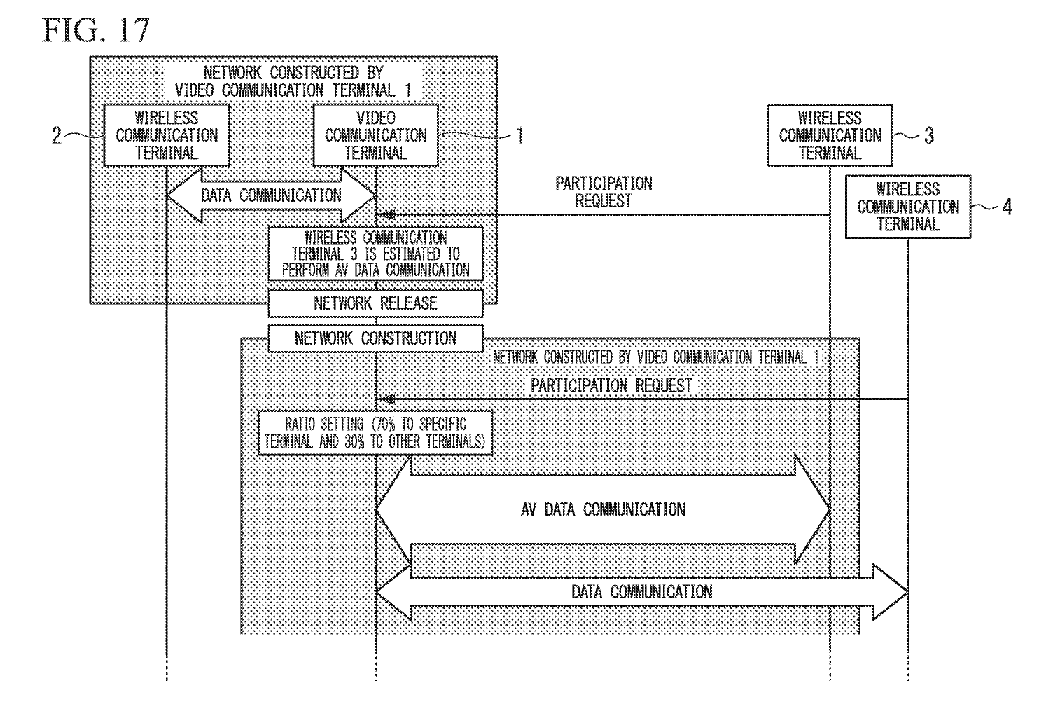

FIG. 17 illustrates an example in which the video communication terminal performs the operation illustrated in FIG. 16. As illustrated in FIG. 17, in a wireless communication system including a video communication terminal 1 and wireless communication terminals 2 to 4, in the initial state, only the wireless communication terminal 2 is participating in a network constructed by the video communication terminal 1 and is performing data communication with the video communication terminal 1. When the participation request from the wireless communication terminal 3 is received, the video communication terminal 1 estimates that the wireless communication terminal 3 is to perform wireless AV data communication (corresponding to steps S103 and S104). Thereafter, the video communication terminal 1 releases the network the video communication terminal 1 has constructed (corresponding to step S131). After the network is released, the video communication terminal 1 newly constructs a network (corresponding to step S201).

The wireless communication terminal 3 is accepted in the newly constructed network. Thereafter, when the wireless communication terminal 4 makes the participation request, the video communication terminal 1 sets a ratio of data communication performed by the wireless communication terminal 3 that is the specific terminal and a ratio of data communication performed by the wireless communication terminal 4 that is not the specific terminal for all data communication performed via the newly constructed network (corresponding to step S242). In the example illustrated in FIG. 17, the ratio of data communication performed by the wireless communication terminal 3 for all data communication is set to 70%, and the ratio of data communication performed by the wireless communication terminal 4 for all data communication is set to 30%. Thereafter, the video communication terminal 1 performs wireless AV data communication with the wireless communication terminal 3 via the constructed network while performing wireless communication of data with the wireless communication terminal 4 via the constructed network (corresponding to step S243).

According to the present embodiment, after a network is newly constructed by the network-constructing unit 100, when the participation request is received from a terminal other than the specific terminal stored in the storage unit 12, the ratio of data communication performed by the specific terminal stored in the storage unit 12 is set to be higher than the ratio of data communication performed by the terminal that has made the participation request. Through this setting, the video communication terminal can cause the terminal other than the specific terminal to also perform wireless communication while reducing deterioration in the quality of wireless communication performed which is caused by influence of wireless communication performed by the terminal other than the specific terminal on wireless AV data communication performed by the specific terminal.

### Fourth Embodiment

Next, a fourth embodiment of the present invention will be described. A constitution of a video communication terminal according to the present embodiment is the same as the constitution illustrated in FIG. 1.

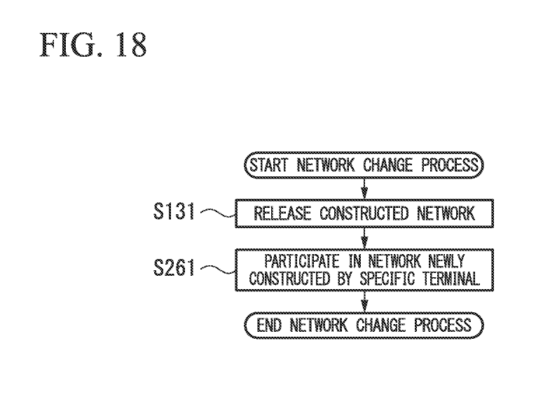

An operation of the video communication terminal according to the present embodiment is similar to the operation illustrated in FIG. 2 except for the network change process in step S106. FIG. 18 illustrates an exemplary network change process according to the present embodiment. After the information identifying the specific terminal is stored in the storage unit 12 in step S105, the communication release unit 103 releases the network constructed by the network-constructing unit 100 (step S131). In step S131, transmission of a beacon frame, reception of a frame of a participation request from another terminal, and transmission of a response frame to the frame of the received participation request are stopped. Thereafter, the communication release unit 103 participates in the network newly constructed by the specific terminal represented by the information stored in the storage unit 12 (step S261). Then, the network change process ends.

For example, the video communication terminal and the specific terminal perform the following process until the video communication terminal participates in the network newly constructed by the specific terminal in step S261 after the network is released in step S131. The video communication terminal and the specific terminal exchange predetermined frames to decide a terminal that constructs a network as an AP. The frames exchanged between the video communication terminal and the specific terminal may include information representing a degree to which each terminal desires to be an AP. For example, when information representing a minimum level is included in the frame as a degree to which the video communication terminal desires to be an AP, the specific terminal constructs a network as an AP, and the video communication terminal transmits the participation request to the specific terminal.

When the network change process ends, in step S107, wireless AV data communication is performed between the video communication terminal and the specific terminal via the network constructed by the specific terminal.

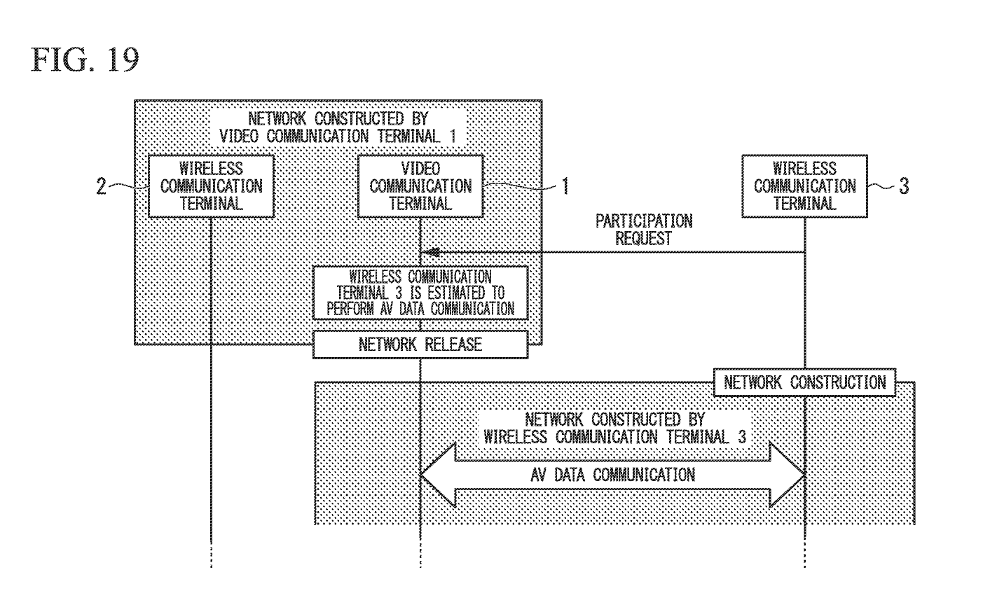

FIG. 19 illustrates an example in which the video communication terminal performs the operation illustrated in FIG. 18. As illustrated in FIG. 19, in the wireless communication system including the video communication terminal 1 and the wireless communication terminals 2 and 3, in the initial state, only the wireless communication terminal 2 is participating in a network constructed by the video communication terminal 1 and is performing data communication with the video communication terminal 1. When the participation request from the wireless communication terminal 3 is received, the video communication terminal 1 estimates that the wireless communication terminal 3 is to perform wireless AV data communication (corresponding to steps S103 and S104). Thereafter, the video communication terminal 1 releases the network the video communication terminal 1 has constructed (corresponding to step S131). After the network is released, the wireless communication terminal 3 constructs a network. The video communication terminal 1 participates in the network constructed by the wireless communication terminal 3 (corresponding to step S261), and performs wireless AV data communication with the wireless communication terminal 3 via the network (corresponding to step S107).

As described above, according to the present embodiment, the video communication terminal can perform wireless AV data communication with the specific terminal via the network constructed by the specific terminal.

### Fifth Embodiment

Next, a fifth embodiment of the present invention will be described. A constitution of a video communication terminal according to the present embodiment is the same as the constitution illustrated in FIG. 1.

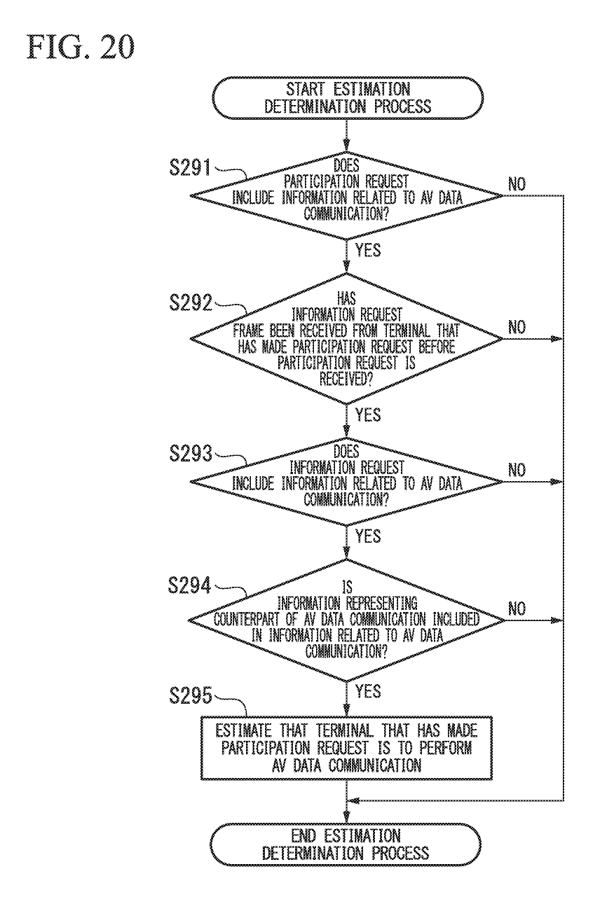

An operation of the video communication terminal according to the present embodiment is similar to the operation illustrated in FIG. 2 except for the estimation determination process in step S103 FIG. 20 illustrates an exemplary estimation determination process according to the present embodiment.

First of all, the AV-estimating unit 102 determines whether or not the frame of the participation request received in step S102 includes information related to AV data communication (step S291).

Examples of the information related to AV data communication include format information of video data or audio data and information representing whether the terminal of the transmission source of the frame of the participation request is a source side (supply side) or a reproducing side. When the frame of the participation request does not include the information related to AV data communication, the estimation determination process ends.

When the frame of the participation request includes the information related to AV data communication, the AV-estimating unit 102 determines whether or not an information request frame has been received from the terminal that has made the participation request before the frame of the participation request is received (step S292). For example, the information request frame is a probe request frame. When it is determined that the information request frame has not been received, the estimation determination process ends.

When it is determined that the information request frame has been received, the AV-estimating unit 102 determines whether or not the received information request frame includes information related to AV data communication (step S293). The information related to AV data communication is the same as the information described in step S291. When the information request frame does not include the information related to AV data communication, the estimation determination process ends.

When the information request frame includes the information related to AV data communication, the AV-estimating unit 102 determines whether or not information representing a counterpart of AV data communication is included in the information related to AV data communication (step S294). The information representing a counterpart of AV data communication is information representing a role that forms a pair with a role of the video communication terminal in information representing a role (a source side (a supply side) or a reproducing side), which is represented in the participation request, supported by the terminal of the transmission source of the frame of the participation request. The information representing a counterpart of AV data communication can represent either or both of the source side and the reproducing side. For example, when the video communication terminal is the source side in AV data communication, in step S294, it is determined that the information representing a counterpart of AV data communication is included when information representing that a counterpart terminal supports the reproducing side or both of the source side and the reproducing side is included in the information related to AV data communication. Further, when the video communication terminal is the source side in AV data communication, in step S294, it is determined that the information representing a counterpart of AV data communication is not included when information representing that a counterpart terminal is the source side is included in the information related to AV data communication.

When the information representing a counterpart of AV data communication is not included, the estimation determination process ends.

Further, when the information representing a counterpart of AV data communication is included, the AV-estimating unit 102 estimates that the terminal that has made the participation request is to perform wireless AV data communication (step S295). Then, the estimation determination process ends. When the process of step S295 is performed, it is estimated in step S104 that the terminal that has made the participation request is to perform wireless AV data communication, and the process of step S105 is performed.

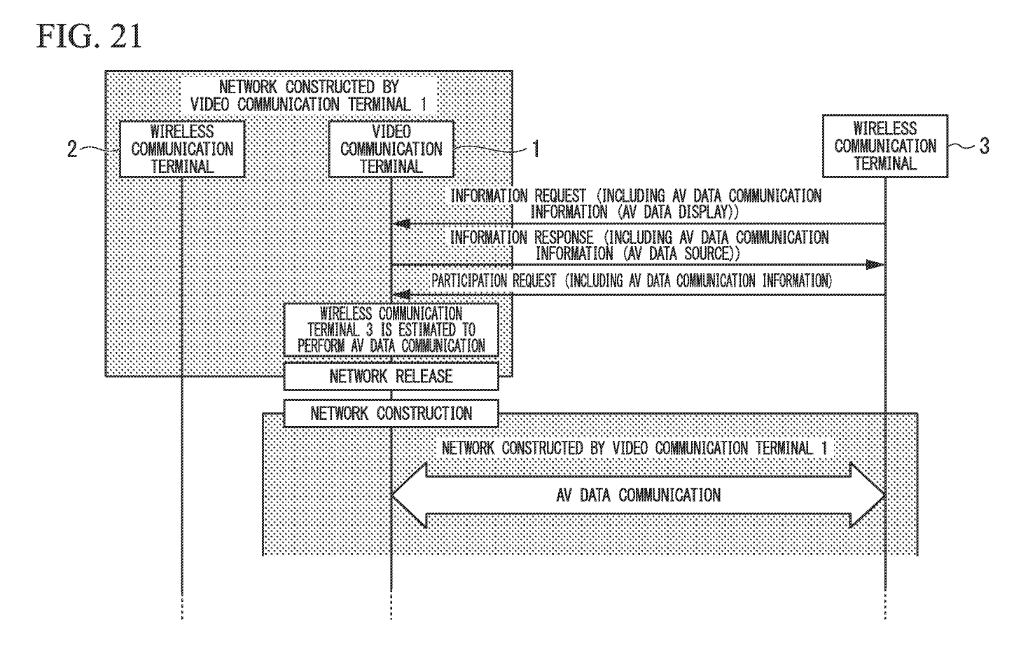

FIG. 21 illustrates an example in which the video communication terminal performs the operation illustrated in FIG. 20. As illustrated in FIG. 21, in the wireless communication system including the video communication terminal 1 and the wireless communication terminals 2 and 3, in the initial state, only the wireless communication terminal 2 is participating in a network constructed by the video communication terminal 1 and is performing data communication with the video communication terminal 1. The wireless communication terminal 3 transmits the information request frame including the information related to AV data communication to the video communication terminal 1. The information related to AV data communication included in the information request frame includes information representing that AV data is displayed as information representing that the wireless communication terminal 3 supports the reproducing side.

When the information request frame is received from the wireless communication terminal 3, the video communication terminal 1 transmits an information response frame including the information related to AV data communication to the wireless communication terminal 3. The information related to AV data communication included in the information response frame includes information representing that the video communication terminal 1 is the source side. Thereafter, the wireless communication terminal 3 transmits the frame of the participation request including the information related to AV data communication to the video communication terminal 1. The information related to AV data communication included in the frame of the participation request includes information representing that AV data is displayed as information representing that the wireless communication terminal 3 is the reproducing side.

When the participation request from the wireless communication terminal 3 is received, the video communication terminal 1 performs the estimation determination process. The information related to AV data communication is included in the frame of the participation request (corresponding to step S291), an information request is received from the wireless communication terminal 3 before the participation request is received (corresponding to step S292), the information related to AV data communication is included in the information request frame (corresponding to step S293), and information representing that AV data is displayed is included in the information related to AV data communication (corresponding to step S294), and thus the video communication terminal 1 estimates that the wireless communication terminal 3 is to perform wireless AV data communication (corresponding to step S295).

Thereafter, the video communication terminal 1 releases the network the video communication terminal 1 has constructed (corresponding to step S131). After the network is released, the video communication terminal 1 newly constructs a network, performs wireless AV data communication with the wireless communication terminal 3 via the constructed network (corresponding to step S107). In FIG. 21, after the network is released, the video communication terminal 1 constructs a network, but the wireless communication terminal 3 may construct a network, and the video communication terminal 1 may participate in the network and perform wireless AV data communication with the wireless communication terminal 3.

According to the present embodiment, based on information included in the frames of the participation request and the information request transmitted from a terminal that is not participating in the network constructed by the video communication terminal, the terminal can estimate whether AV data communication is to be performed.

### Sixth Embodiment

Next, a sixth embodiment of the present invention will be described. A constitution of a video communication terminal according to the present embodiment is the same as the constitution illustrated in FIG. 1.

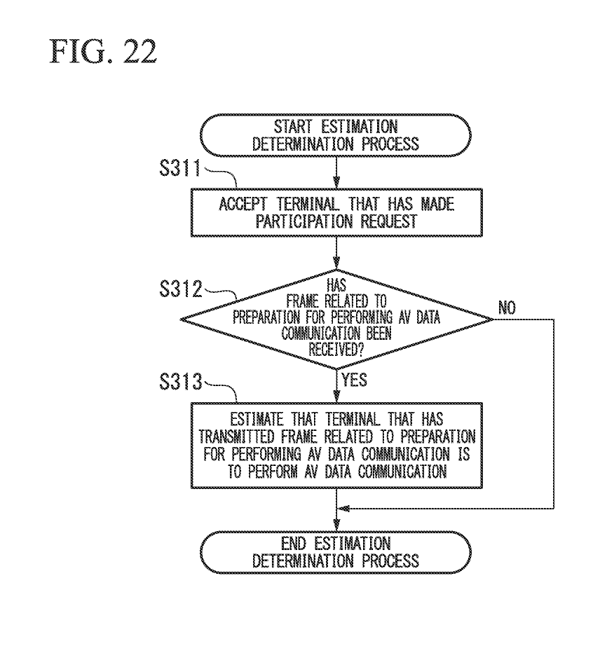

An operation of the video communication terminal according to the present embodiment is similar to the operation illustrated in FIG. 2 except for the estimation determination process in step S103. FIG. 22 illustrates an exemplary estimation determination process according to the present embodiment.

First of all, the AV-estimating unit 102 performs a process of accepting the terminal that has made the participation request in the network constructed by the network-constructing unit 100 (step S311). In step S311, for example, a response frame (for example, an association response frame) representing the acceptance is transmitted to the terminal from which the participation request has been received in step S102 through the wireless communication unit 11. Further, in step S311, information of the accepted terminal is stored in the storage unit 12. When the participation request received in step S102 is based on a frame having a distinctive format rather than the association request frame, in step S311, the response frame may not be transmitted, and the information of the accepted terminal may be stored in the storage unit 12.

Thereafter, the AV-estimating unit 102 determines whether or not a frame related to preparation for performing wireless AV data communication has been received (step S312). The frame related to preparation for performing wireless AV data communication is a frame including information representing reproduction capability (for example, a format of corresponding AV data) of AV data of the reproducing side when the video communication terminal 1 is the source side of AV data. Further, the frame related to preparation for performing wireless AV data communication is a frame including information representing a format of AV data designated by the source side when the video communication terminal 1 is the reproducing side of AV data.

For example, when the video communication terminal 1 is the source side of AV data, in step S312, it is determined that the frame related to preparation for performing wireless AV data communication has been received when a frame including information representing reproduction capability of AV data has been received. Further, when the video communication terminal 1 is the reproducing side of AV data, in step S312, it is determined that the frame related to preparation for performing wireless AV data communication has been received when a frame including information representing a format of AV data has been received. In any other case, it is determined that the frame related to preparation for performing wireless AV data communication has not been received.

When it is determined that the frame related to preparation for performing wireless AV data communication has not been received, the estimation determination process ends. Further, when it is determined that the frame related to preparation for performing wireless AV data communication has been received, the AV-estimating unit 102 estimates that a terminal that has transmitted the frame related to preparation for performing wireless AV data communication is to perform wireless AV data communication (step S313). Then, the estimation determination process ends. When the process of step S313 is performed, in step S104, it is determined that the terminal that has made the participation request is estimated to perform wireless AV data communication, and the process of step S105 is performed.

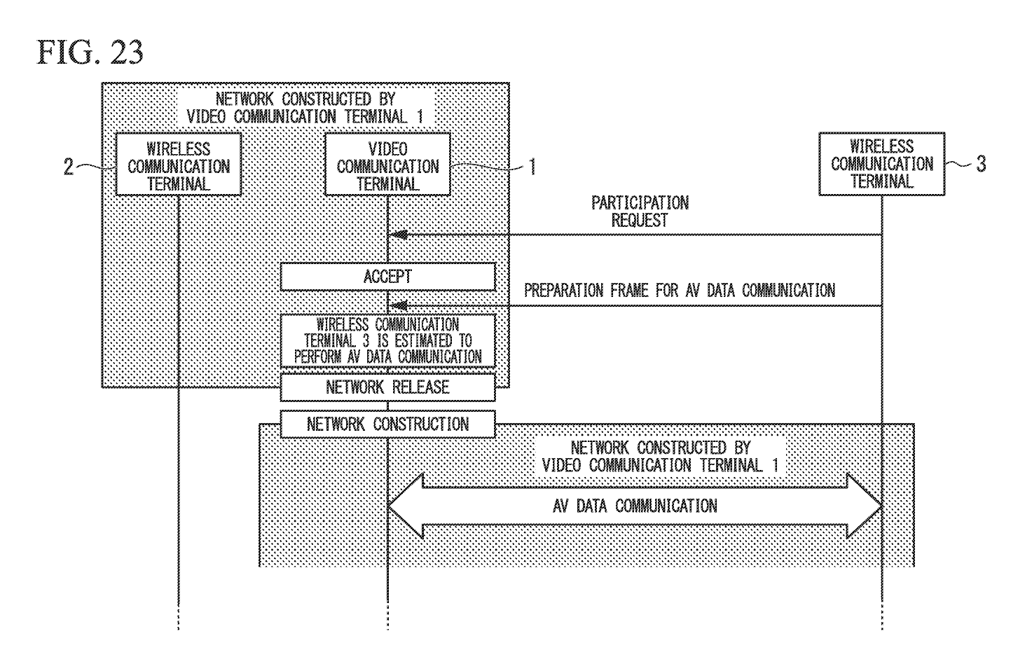

FIG. 23 illustrates an example in which the video communication terminal performs the operation illustrated in FIG. 22. As illustrated in FIG. 23, in the wireless communication system including the video communication terminal 1 and the wireless communication terminals 2 and 3, in the initial state, only the wireless communication terminal 2 is participating in the network constructed by the video communication terminal 1, and is performing data communication with the video communication terminal 1. When the wireless communication terminal 3 transmits the frame of the participation request to the video communication terminal 1, the video communication terminal 1 accepts the wireless communication terminal 3 that has made the participation request in the network constructed by the network-constructing unit 100 (corresponding to step S311).

Thereafter, the wireless communication terminal 3 transmits the frame related to preparation for performing wireless AV data communication to the video communication terminal 1. Upon receiving the frame (corresponding to step S312), the video communication terminal 1 estimates that the wireless communication terminal 3 is to perform wireless AV data communication (corresponding to step S313).

Thereafter, the video communication terminal 1 releases the network the video communication terminal 1 has constructed (corresponding to step S131). After the network is released, the video communication terminal 1 newly constructs a network, and performs wireless AV data communication with the wireless communication terminal 3 via the constructed network (corresponding to step S107). In FIG. 23, after the network is released, the video communication terminal 1 constructs a network, but the wireless communication terminal 3 may construct a network, and the video communication terminal 1 may participate in the network and perform wireless AV data communication with the wireless communication terminal 3.

According to the present embodiment, based on the frame related to preparation for performing wireless AV data communication, which is transmitted from a terminal that is participating in the network constructed by the video communication terminal, it is possible to estimate whether or not the terminal is to perform AV data communication.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A wireless communication terminal, comprising:
a network-constructing unit that constructs a wireless network;
a receiving unit that receives a participation request from a first terminal that is not participating in the wireless network constructed by the network-constructing unit;
an estimating unit that estimates whether or not the first terminal is to perform wireless communication of streaming data used for streaming of content based on information received from the first terminal when the participation request is received;
a storage unit that stores the first terminal as a specific terminal when the first terminal is estimated to perform the wireless communication of the streaming data;
a communication release unit that performs a process of releasing wireless communication with a second terminal that is participating in the wireless network constructed by the network-constructing unit when the first terminal is estimated to perform the wireless communication of the streaming data; and
a wireless communication unit that performs the wireless communication of the streaming data with the specific terminal stored in the storage unit after the wireless communication with the second terminal is released.

2. The wireless communication terminal according to claim 1,
wherein, after the wireless network constructed by the network-constructing unit is released, the wireless communication unit performs the wireless communication of the streaming data with the specific terminal stored in the storage unit via a network newly constructed by the network-constructing unit or by a third terminal other than the specific terminal stored in storage unit.

3. The wireless communication terminal according to claim 2,
wherein the communication release unit performs a process of notifying the second terminal of release of the wireless network, and then releases the wireless network.

4. The wireless communication terminal according to claim 3,
wherein the communication release unit performs a process of notifying the second terminal that is in a state in which data communication of a predetermined protocol has begun and before the data communication has ended of release of the wireless network, among all of the second terminals.

5. The wireless communication terminal according to claim 3,
wherein the communication release unit performs a process of notifying the second terminal that has performed data communication of a predetermined protocol within a certain past period of time of release of the wireless network, among all of the second terminals.

6. The wireless communication terminal according to claim 3,
wherein, when information related to a timing at which the wireless network is released is included in a response frame from the second terminal that is given notification of releases of the wireless network, the communication release unit releases the wireless network at a timing corresponding to the information.

7. The wireless communication terminal according to claim 2,
wherein the network-constructing unit newly constructs a wireless network after the wireless network is released.

8. The wireless communication terminal according to claim 7,
wherein, when the participation request is received from each of a plurality of the first terminals, the estimating unit estimates whether or not each of the first terminals is to perform the wireless communication of the streaming data used for streaming of content based on information received from each of the first terminals,
the storage unit stores each of the first terminals as a specific terminal when it is estimated that each of the first terminals is to perform the wireless communication of the streaming data, and
the wireless communication unit performs the wireless communication of the streaming data with a plurality of specific terminals stored in the storage unit via a newly constructed wireless network when a plurality of first terminals are estimated to perform the wireless communication of the streaming data.

9. The wireless communication terminal according to claim 8,
wherein the streaming data includes video data and audio data, and
the wireless communication unit wirelessly transmits the video data to some of the plurality of specific terminals stored in the storage unit via a newly constructed wireless network, and wirelessly transmits the audio data to the specific terminals other than the specific terminal to which the video data has been wirelessly transmitted among the plurality of specific terminals stored in the storage unit via a newly constructed wireless network.

10. The wireless communication terminal according to claim 7, further comprising,
a response control unit that controls the wireless communication unit to wirelessly transmit a response frame representing rejection of participation to the third terminal that has made a participation request or not to wirelessly transmit the response frame to the participation request, after a wireless network is newly constructed by the network-constructing unit, when the participation request is received from the third terminal that is not participating in the wireless network.

11. The wireless communication terminal according to claim 10,
wherein the response control unit controls the wireless communication unit to wirelessly transmit a response frame that includes information representing that the number of terminals that are participating in the wireless network is a predetermined number or more and represents rejection of participation to the third terminal that has made the participation request, when the number of terminals that are participating in a wireless network newly constructed by the network-constructing unit is a predetermined number or more.

12. The wireless communication terminal according to claim 7, further comprising,
a communication-setting unit that, after a wireless network is newly constructed by the network-constructing unit, when a participation request is received from the third terminal that is not participating in the wireless network, sets a ratio of data communication performed along with the specific terminal stored in the storage unit to be higher than a ratio of data communication performed along with the third terminal, and
the wireless communication unit performs the wireless communication of the streaming data with the specific terminal stored in the storage unit via a newly constructed wireless network and wireless communication of data with the third terminal via a newly constructed wireless network according to the ratio set by the communication-setting unit.

13. The wireless communication terminal according to claim 12,
wherein the communication-setting unit sets the ratio of data communication performed along with the specific terminal stored in the storage unit to a value larger than “0” and sets the ratio of data communication performed along with the third terminal to “0.”

14. The wireless communication terminal according to claim 1,
wherein, when the participation request is received, the estimating unit estimates whether or not the first terminal is to perform the wireless communication of the streaming data based on information included in the frame of the participation request and information transmitted before the first terminal that has made the participation request makes the participation request.

15. The wireless communication terminal according to claim 1,
wherein, after the first terminal that has made the participation request participates in the wireless network constructed by the network-constructing unit, when information representing reproduction capability of streaming data used for streaming of content or information representing a kind of streaming data supported by the first terminal is received from the first terminal, the estimating unit estimates whether or not the first terminal is to perform the wireless communication of the streaming data based on the information.

16. The wireless communication terminal according to claim 1,
wherein, after wireless communication with a terminal other than the specific terminal stored in the storage unit is released, the wireless communication unit performs the wireless communication of the streaming data with the specific terminal stored in the storage unit via a wireless network newly constructed by the specific terminal.

17. The wireless communication terminal according to claim 1,
wherein when a plurality of second terminals are participating in the wireless network constructed by the network-constructing unit, the communication release unit disconnects a connection with all of the second terminals, and
after the connection with all of the second terminals is disconnected, the wireless communication unit establishes a connection with the specific terminal stored in the storage unit, and performs the wireless communication of the streaming data with the specific terminal.

18. A wireless communication system, comprising:
a wireless communication terminal including
a network-constructing unit that constructs a wireless network,
a receiving unit that receives a participation request from a first terminal that is not participating in the wireless network constructed by the network-constructing unit,
an estimating unit that estimates whether or not the first terminal is to perform wireless communication of streaming data used for streaming of content based on information received from the first terminal when the participation request is received,
a storage unit that stores the first terminal as a specific terminal when it is estimated that the first terminal is to perform the wireless communication of the streaming data,
a communication release unit that performs a process of releasing wireless communication with a second terminal that is participating in the wireless network constructed by the network-constructing unit when it is estimated that the first terminal is to perform the wireless communication of the streaming data, and
a wireless communication unit that performs the wireless communication of the streaming data with the specific terminal stored in the storage unit after the wireless communication with the second terminal is released; and
a specific terminal that wirelessly transmits the participation request, and performs the wireless communication of the streaming data with the wireless communication terminal.

19. A wireless communication method performed by a wireless communication terminal including a network-constructing unit that constructs a wireless network, a storage unit that stores information, and a wireless communication unit that performs wireless communication, the method comprising:
receiving a participation request from a first terminal that is not participating in the wireless network constructed by the network-constructing unit;
estimating whether or not the first terminal is to perform wireless communication of streaming data used for streaming of content based on information received from the first terminal when the participation request is received;
storing the first terminal as a specific terminal in the storage unit when the first terminal is estimated to perform the wireless communication of the streaming data;
performing a process of releasing wireless communication with a second terminal that is participating in the wireless network constructed by the network-constructing unit when the first terminal is estimated to perform the wireless communication of the streaming data; and
performing the wireless communication of the streaming data with the specific terminal stored in the storage unit after the wireless communication with the second terminal is released.

20. A computer-readable storage device storing a program executed by a computer of a wireless communication terminal including a network-constructing unit that constructs a wireless network, a storage unit that stores information, and a communication unit, the program causing the computer to execute:
receiving a participation request from a first terminal that is not participating in the wireless network constructed by the network-constructing unit;
estimating whether or not the first terminal is to perform wireless communication of streaming data used for streaming of content based on information received from the first terminal when the participation request is received;
storing the first terminal as a specific terminal in the storage unit when the first terminal is estimated to perform the wireless communication of the streaming data;
performing a process of releasing wireless communication with a second terminal that is participating in the wireless network constructed by the network-constructing unit when the first terminal is estimated to perform the wireless communication of the streaming data; and
performing the wireless communication of the streaming data with the specific terminal stored in the storage unit after the wireless communication with the second terminal is released.
